(19) United States
(12) Patent Application Publication
(10) Pub. No.: US 2019/0344285 A1
(43) Pub. Date: Nov. 14, 2019

(54) Process For Cleaning Dirty Post-Consumer Waste Glass

(71) Applicant: Urban Mining Northeast, LLC, New Rochelle, NY (US)

(72) Inventors: Louis P. Grasso, Jr., New Rochelle, NY (US); Dale Hauke, Northlake, TX (US)

(73) Assignee: Urban Mining Northeast, LLC, New Rochelle, NY (US)

(21) Appl. No.: 16/523,590

(22) Filed: Jul. 26, 2019

Related U.S. Application Data
(63) Continuation-in-part of application No. 15/154,361, filed on May 13, 2016, now Pat. No. 10,369,575.
(60) Provisional application No. 62/208,122, filed on Aug. 21, 2015.

(51) Int. Cl. B02C 23/24; B02C 19/00; B02C 23/08; B07B 15/00; C03C 23/00

(52) U.S. Cl. CPC B02C 23/24; B02C 19/0087; C03C 23/0085; B07B 15/00; C03C 23/0075; B02C 23/08

(57) ABSTRACT

A method is provided to clean glass mixed with non-glass undifferentiated trash. In the method, the glass pieces are cleaned without washing the glass pieces with water or a surfactant during the cleaning process. The non-glass contaminants are liberated from the glass by drying and abrasion, and then removed from the glass by screening and density separation.

### CROSS-REFERENCE TO RELATED APPLICATIONS

This application is a continuation-in-part of U.S. Ser. No. 15/154,361, filed May 13, 2016, which claims benefit to U.S. Prov. Ser. No. 62/208,122, filed Aug. 21, 2015, both of which are hereby incorporated by reference herein in their entireties.

### BACKGROUND OF THE INVENTION

### 1. Field of the Invention

The present invention relates to a process to clean dirty waste glass that is comingled with undifferentiated trash. The invention also relates to further processing of the clean glass into ground glass products.

### 2. State of the Art

Material recovery facilities (MRFs) receive recyclable materials. In a relatively automated process, a MRF separates recyclables collected primarily from residential curbsides into homogeneous product streams (e.g., cardboard, mixed paper, aluminum cans, etc.). In addition, such recyclable glass-containing materials can be received from other sources. Other sources include, but are not limited to, restaurant and bar bottle collection companies, construction and demolition MRFs, municipal solid waste (MSW) incinerator bottom ash, any type of glass product manufacturing process. For purposes herein, MRF shall be used to inclusively represent all of these sources.

There are two types of MRFs: single stream and dual stream. Initially, all residential MRFs were dual stream. In a dual stream MRF, paper products are collected separately from cans, bottles and plastics. A dual stream MRF has picking lines where unbroken clear and amber bottles are hand-picked and color separated, with the broken and green glass disposed. With the advancement of MRF processing technology allowing for more capital intensive automation that is cost justified by the reduction in labor effort, most dual stream MRFs converted to single stream.

For single stream MRF processing, all recyclables are comingled at the curbside. Glass is a problem in a single stream MRF because of the damage glass can cause to the processing equipment. Therefore, most single stream MRFs crush the comingled materials and screen the glass out early in the sorting and separation process, often after cardboard removal. Along with the glass comes bits and pieces of plastic, paper, ferrous and non-ferrous metals, ceramics, stones, dirt and organics such as pizza crust, etc.

Typical single stream MRF residue is 70%-85% glass, 1%-10% moisture and the remaining being undifferentiated trash. The broken glass size is typically 2 to 3 inches and smaller (2 or 3 inch minus). The plastic fraction may contain large pieces (e.g., whole plastic bottles, plastic bags) down to bottle cap size pieces and smaller. The non-ferrous material is mostly aluminum with small quantities of solid non-ferrous objects such as brass fittings. Although the moisture content is relatively low, the material appears wet because most of the moisture is contained in the paper component. Due to the paper wetness, the paper adheres to the glass and other solid components.

The current basic method to separating the glass from the non-glass components includes pulverizing the material as it is received from the MRF. This reduces the glass size from two inch minus to ⅜ inch minus without reducing the size of most of the non-glass components. A simple screen then achieves a reasonably good separation. There are, however, small bits and pieces of foreign materials as well as the liquid organic component from the glass bottle contents left behind with the glass. The fundamental problem with this method results from the size reduction. Not only does it generate a significant amount of fines (e.g., glass powder less than 40 mesh), it spreads the liquid organic fraction over a significantly larger surface area. Both of these issues cause subsequent cleaning challenges.

The cleaning has been accomplished by one of two methods: washing and baking. Washing the glass is a proven effective method, but all of the fines end up in the waste water sludge which not only loses potential glass product, the sludge is difficult to dewater and handle. The other method is baking the contaminants off in a fluidized bed dryer at 400° F. The action of fluidization causes particle-on-particle collisions, which knocks most of the baked organic material off of the glass. There must be sufficient residence time and air flow to achieve sufficient cleanliness. The problem is that the airflow required to remove the contaminants to a dust collector from the fluidized glass also removes the glass fines.

The only known installation using fluidized heat to clean dirty MRF glass so far has been unable to produce sufficiently clean glass on a consistent basis. A sample of purportedly clean residue was obtained from the installation and subjected to testing under a loss on ignition (LOI) test. Such a test, measures how much of a product is lost, by weight, upon burning. Where there is a high organic component, the loss will be relatively high. When several samples were tested, the overall loss was measured at 1.44%. While this may not seem high, such a result indicates that the purportedly clean glass still contained unsuitably high organics for various end-uses, including use as a pozzolan.

### SUMMARY OF THE INVENTION

A method is provided to clean glass mixed with non-glass undifferentiated trash. In accord with one aspect of the method, the glass pieces are broken and abraded into small enough pieces to maximize abrasion and liberation of material from the glass. In accord with another aspect of the method, the glass pieces are cleaned without washing the glass pieces with water or a surfactant during the cleaning process. The method requires liberating the non-glass contaminants from the glass by drying and abrasion, and then removing the liberated contaminants by screening and density separation.

In accord with one method, the following steps to clean dirty MRF glass are performed, which may be altered depending on various optional aspects of the method. The steps include:

1. Screen out large foreign materials

2. Dry and disassociate components.

Then, preferably, in order:

3. Remove ferrous metals.

4. Screen the glass pieces into particle size categories.

5. Separate light materials from heavy materials in the size-categorized glass.

6. Optionally, isolate colored glass.

7. Remove non-ferrous metals from the glass pieces.

8. Comminution of the cleaned glass to appropriate size.

The resulting clean glass can be further processed into a number of products that range in size from sub-micron to 1½ inch glass aggregate. These products include, but are not limited to, fine grind products such as pozzolans for use as a cement replacement in concrete and industrial fillers for use in coatings and resins, sand-sized products such as abrasive blasting media, water filtration media, specialty sands paver joint sand, sealcoating sand and non-crystalline silica play sand, and finally aggregate sized products for use in landscaping, decorative concrete, fire pits, etc.

Furthermore, the product may be sanitized to remove active biologics so that the products can be used in medical applications, clean-room applications, or other applications requiring a sanitized product. Such sanitization can occur during the initial drying step, or during or after another disclosed step.

In accord with one method, the following steps are performed during cleaning of the dirty MRF glass, including:

1. tumble the mixture in a rotary drum so that the glass leaving the exit of the drum has a particle size that, on average, is less than two-thirds, or preferably less than half the size of the particle size of the glass entering the entrance to the drum;

2. after the glass exits the exit of the drum, separate ferrous metals from the glass;

3. separate the glass into multiple particle size categories;

4. in each of the multiple particle size categories, separate the glass from the trash; and

5. pulverize the separated glass.

In accord with another method, the following steps are performed during cleaning of the dirty MRF glass, including:

1. tumble the mixture in a rotary drum so that the glass leaving the exit of the drum has a particle size that, on average, is less than two-thirds, or preferably less than half the size of the particle size of the glass entering the entrance to the drum;

2. after the mixture exits the exit of the drum, separate ferrous metals from the mixture;

3. density separate the mixture into a heavy component and a light component, the heavy component containing a glass fraction and non-glass fraction, and the light component including only dried organic materials removed by the tumbling; and

4. for the heavy component, separate the glass fraction from the non-glass fraction.

Additional aspects of the method will become apparent with reference to the detailed description below.

### BRIEF DESCRIPTION OF THE DRAWINGS

FIG. 1 is a process flow diagram for a glass cleaning portion of the process.

FIG. 2 is a process flow diagram for a grinding portion of the process.

FIG. 3 is a view of the interior of an embodiment of a rotary dryer drum or tumbler in accordance with an aspect of the disclosure.

FIG. 4 is a process flow diagram for another glass cleaning portion of an alternate process to that shown in FIG. 1

FIG. 5 is a process flow diagram for another glass cleaning portion of an alternate process to those shown in FIGS. 1 and 4.

### DETAILED DESCRIPTION OF THE PREFERRED EMBODIMENTS

A method is provided to clean glass mixed with non-glass undifferentiated trash. In accord with one aspect of the method, the glass pieces are broken and abraded into small enough pieces to maximize abrasion and liberation of material from the glass. In accord with another preferred aspect of the method, the glass pieces are cleaned without washing the glass pieces with water or a surfactant during the cleaning process.

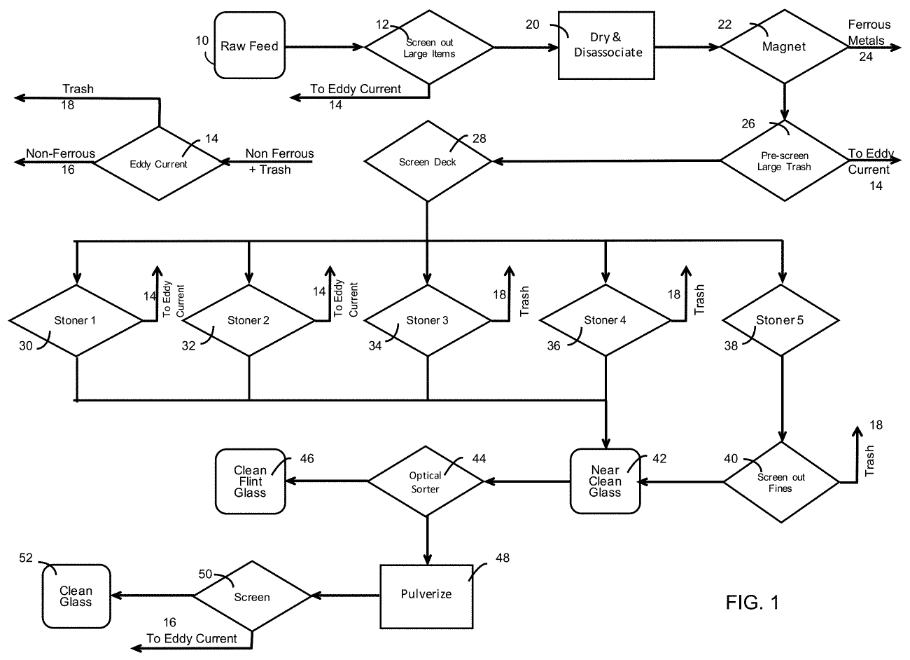

Turning now to FIG. 1, the method to clean the dirty glass mixed with non-glass undifferentiated trash (residue) includes the following steps. The dirty glass with residue is received at 10 from storage, shipment, or conveyance. As indicated above, the residue contains moisture content, generally of 1%-10%, mostly held in a wet paper constituent of the residue. While the residue may contain some moisture, the method shown in FIG. 1 and described herein, is not designed to add additional moisture to the residue, such as by washing or rinsing the residue.

A first step at 12 may optionally include screening out larger foreign materials from the glass constituent. The raw material is a mixture that contains glass and larger plastic pieces (e.g., 4 inch diameter plastic lids, plastic bags, etc.) that can be removed prior to a subsequent glass separation processes, discussed below. This screening 12 can be achieved by a stationary grizzly, vibratory screen or a cylindrical trommel type screen. The most problematic materials are plastic bags which can trap a significant amount of glass which gets lost when the bags are removed. The preferred method is a rotary screen or trommel screen 12 because the tumbling action of the screen empties the plastic bags. The size of screen aperture will depend on raw material glass size, but typically is between 2-3 inches. The larger trash from the screen 12 is sent to an eddy current system 14 that further separates non-ferrous metal from trash, for respective storage of each: non-ferrous metal storage at 16 and trash storage at 18.

Next, the screened glass or the mixture of glass and larger foreign material is sent to a drying operation at 20 where the glass is dried, polished, and disassociated from other materials attached to the glass. Thus, due to the stickiness of the wet paper, a first stage of the workflow in FIG. 1 can include sufficiently drying, polishing, and agitating the raw residue to disassociate all of the disparate materials and liberate the glass, prior to the screening at 12. However, the method, for purposes of the description herein, will assume screening 12 prior to this drying step 20, as shown in FIG. 1. The drying operation 20 reduces moisture content to an acceptable level. The disassociation of components liberates the glass. Polishing removes dried organic liquids and semi-liquids and labels off of the glass. As noted above, no water is added to wet or wash away the organic materials. Instead, organics (when dried) are effectively liberated from the glass by mechanical abrasion (i.e., polishing), combined with tumbling of the material in the presence of heating to dry the organics.

While several different drying technologies can be used, a preferred drying operation uses a rotary dryer. A rotary dryer is made up of a large, rotating cylindrical tube or drum, usually supported by concrete columns or steel beams. The dryer is configured to slope slightly so that the discharge end is lower than the material feed end in order to convey the material through the dryer under gravity. Rotary dryers are effective in drying materials because the dryer lifts the materials and drops them through a stream of hot gasses. The residue material to be dried enters the dryer, and as the dryer rotates, the material is lifted up by a series of internal fins (otherwise referred to as “lifters”, “lifting paddles”, or “flights”) lining the inner wall of the drum of the dryer. When the material is elevated high enough in the drum to fall back off the fins, the material falls back down to the bottom of the drum of the dryer, passing through a hot gas stream that flows through the drum as the material falls.

In comparison to conventional cleaning operations that add water to the glass to wash the glass, the drying 20 taking place in the workflow in FIG. 1 takes relatively less energy because of the overall low moisture content which ranges from 1% to 10%, but typically around 2.5%. Nearly all of the moisture is contained in the paper portion of the waste glass stream which sticks to the glass and other components. In the case of conventional processes where water is added, more energy is required to remove the higher amount of moisture. Moreover, conventional drying processes use relatively more energy because their objective after washing the glass is not only to dry the glass, but to raise the temperature of the fed material sufficiently to combust or burn off the organic materials from the glass. This is very different from the objectives of the drying 20 in the workflow in FIG. 1, which aims to raise the temperature inside the dryer sufficiently to dry the material fed into the dryer to disassociate the paper and other materials from the glass without causing combustion of the paper and other materials.

Furthermore, in addition to drying the glass and the organics, the rotation of the drum of the dryer also facilitates disassociation of paper and other materials from the glass by abrading the dried organics and labels off of the glass. Thus, the drying 20 in accordance with the present disclosure combines drying and abrading (i.e., polishing) operations to clean the waste glass without prior, simultaneous, or post operations that use a washing fluid or combustion of the organics and paper. Thus, the cleaning operations are very different from other conventional processes that either wash the glass, heat organics to combust them, and/or attempt to minimize abrasion of glass in order to avoid breakage of glass into smaller pieces.

In the drying operation 20, the dried organics (e.g., food particles) are abraded off the glass rather easily, however the dried labels may not be as easily removed. Rotary dryers typically have paddles that tumble the material to be dried. As noted above, some rotary dryers employ paddles, lifters, or flights that are designed to minimize abrasion of the glass as the glass is tumbled so as to avoid unnecessary breakage of the glass to keep the glass pieces as large as possible for sorting after drying. The inventors have discovered that abrasion of labels can be facilitated by using more aggressive abrasion means, such as more “aggressive” paddles, lifters, or flights (hereinafter referred to as lifters) inside the drum of the dryer. Such aggressive lifters can be constructed to lift material higher within the drum than conventional lifters before releasing the material to fall inside the drum (e.g., to the bottom of the drum). Acceleration due to gravity causes the falling material to increase in velocity before impact. The greater the velocity of the falling material upon impact, the greater the abrasion action on the labels attached to the glass. However, the greater the velocity, the greater the breakage of the glass occurring in the drum of the dryer, and, thus, the glass is reduced to smaller particle sizes than if the material was dropped from relatively lower heights inside the drum. The aggressive lifters are configured such that the glass leaving the exit of the drum has a particle size that, on average, is less than two-thirds, or preferably less than half the size of the particle size of the glass entering the entrance to the drum. On the other hand, to minimize breakage and maintain larger particle sizes, as is conventionally done, one would use lifters of a different design so that the material that falls a much shorter distance and is more gently tumbled.

The lifters may be adjustable so that for a given rotational speed, the lifters can be set to drop material at whatever height may be desired. The inventors have found that, in forming waste glass into a pozzolan, for which the glass must be very finely ground, e.g., 325 mesh, it is beneficial to maximize abrasion and breakage of material fed into the dryer by lifting the material in the drum to fall substantially from a height that is above the center (at least half of the height) of the interior diameter of drum, and more preferably from a height proximate to a top of the inner wall of the drum. Upon exit of the broken glass from the drum, further processing with magnets, gravity and density separators isolates the broken glass from non-glass material.

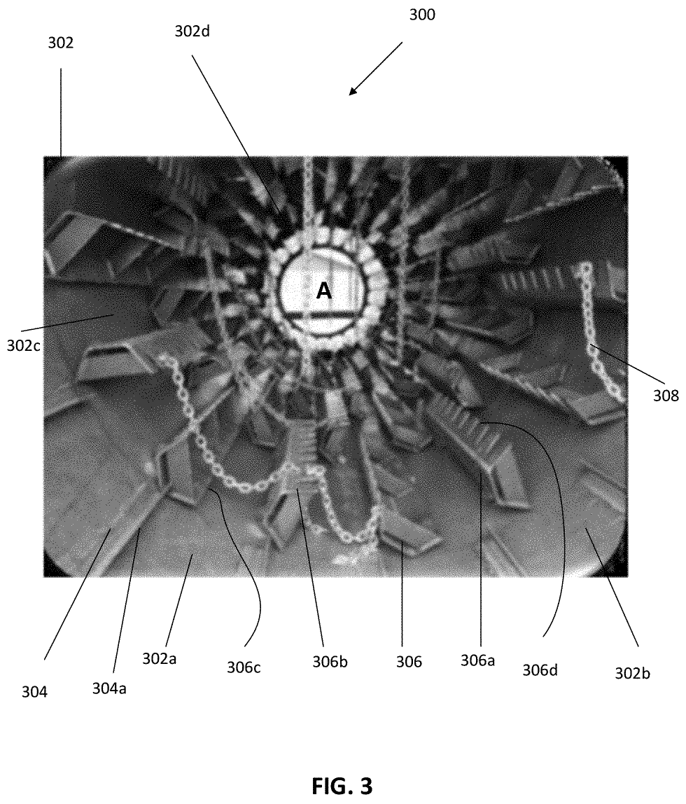

FIG. 3 shows the interior of a portion of one embodiment of a drum 302 of a rotary dryer 300 in accordance with an aspect of the disclosure. The drum 302 extends longitudinally along an axis A (in and out of the page in FIG. 3). Extending radially and longitudinally from the inner wall 302a of the drum 302 are standard lifters 304 and adjustable lifters 306. The standard lifters 304 may have elongated fins 304a that extend radially about two to three inches from the inner wall 302a of the drum 302. In one embodiment, the rotary dryer 300 may include standard lifters 304 at a burner zone 302b of the dryer proximate a burner (not shown) of the dryer 300 to protect the inner wall 302a of the drum 302 from radiant heat from the burner. The standard lifters 304 at the burner zone 302b may be referred to as combustion lifters. The combustion lifters 304 are designed so that they do not veil the fed material through the burner flame, and they do not quench the combustion process.

The adjustable lifters 306 in FIG. 3 are axially spaced from the standard lifters 304, and the adjustable lifters 306 may be located in a drying zone 302c and/or a heating zone 302d of the drum 302, which are axially spaced from the burner zone 302b, as shown in FIG. 3. In the embodiment shown in FIG. 3, each adjustable lifter 306 has a bottom 306a (which may be flat or curved) and side walls 306b and 306c forming a scoop. The radially inner side wall 306b of each adjustable lifter 306 may have an upper edge 306d having a sawtooth pattern with teeth configured to dig into, comb through, and break up material being scooped into the lifter at the bottom of the drum as well as break glass that might fall and hit the teeth. The adjustable lifters 306 can be adjusted relative to the inner wall 302a of the drum 302 to adjust a discharge height at which scooped material is discharged from the lifter 306 (i.e., the height at which the material is dropped). Preferably, the discharge height is adjusted so as to drop the scooped material at a height sufficient to cause abrasion to the glass that will liberate paper and any other materials from the glass. For example, the angle of the radially inner sidewall 306b of the lifters may be angled more or less with respect to the radial direction so that scooped material will be held in the scoop through a certain height before being dumped out of the lifter 306 due to the rotation of the lifter 306 with the drum 302. In one embodiment, the lifters 306 may be coupled to the inner wall 302a of the drum 302 with an adjustable pivotal coupler (e.g., a lockable hinge) that permits the lifter to be pivotally adjusted relative to the inner wall 302a of the drum 302. In addition to the lifters 306, additional abrasion means may be included in the drum 302, such as metal chains 308 that may be attached to the lifters 306 and/or the inner wall 302a of the drum 302 and which are constructed to impinge upon glass moving through the drum 302.

The gas stream in the dryer can either be moving toward the discharge end from the feed end (known as co-current or parallel flow), or toward the feed end from the discharge end (known as counter-current or counter flow). When counter-current flow is used, the material being dried exits the dryer at a higher temperature than at the inlet of the dryer. When co-current flow is used, the material being dried exits the dryer at a lower temperature than at the inlet of the dryer. It has been found that co-current flow is preferred over counter-current flow because it permits the organic materials to be dried without causing combustion thereof and allows the glass exiting the dryer to be cooler than if a counter-current flow were used. The gas stream can comprise a mixture of air and combustion gases from a burner, in which case the dryer is called a direct heated dryer. Alternatively, the gas stream may comprise air or another (sometimes inert) gas that is preheated. When the gas stream is preheated by some means where burner combustion gases do not enter the dryer, the dryer known as an indirect-heated type. Often, indirect heated dryers are used when product contamination is a concern. It is also possible to use a combination of direct-indirect heated rotary dryers to improve the overall efficiency.

The action of lifting and dropping the material in the drum thoroughly disassociates the components and liberates the glass. This action also reduces the size of the glass to which extent depends on the residence time. For example, a test in a rotary dryer with a residence time of 30 minutes reduced the glass size from 2 inch minus to less than ¼ inch. Shorter residence time will result in less size reduction. The lifting and dropping action also eliminates all (or substantially all) of the sharp edges and polishes most of the organic material off of the glass. The only remaining organic material on the glass are residual labels on approximately 1%-10% of the larger glass pieces. Shorter residence times will result in more residual labels on the glass. Longer residence times will result in further reduction of moisture content, enhanced liberation and disassociation of the glass from bottle labels, enhanced removal of organic contaminants, and additional polishing of the edges of the glass.

Any type of rotary dryer can be used including but not limited to direct fired, indirect fired, combined direct and indirect, co-current flow, counter-current flow, natural gas or electric. However, as noted above, it has been found that co-current flow is preferred over counter-current flow.

Further, as one alternative to a rotary dryer, a heated fluidized bed dryer may be used. A fluidized bed is formed when a quantity of a solid particulate substance (usually present in a holding vessel) is placed under appropriate conditions to cause a solid/fluid mixture to behave as a fluid. This is usually achieved by the introduction of pressurized fluid (normally air) through the particulate medium. This results in the medium then having many properties and characteristics of normal fluids, such as the ability to free-flow under gravity, or to be pumped using fluid type technologies. When heated air is used to fluidize the material bed, it imparts a drying effect to remove moisture from the residue. Since there are particle-on-particle collisions in the fluidization process, the disparate materials are dissociated, hence liberating the glass. However, using this method to dry and liberate the glass will result in very little size reduction of the glass and is less efficient in polishing labels and other organics off of the glass than a rotary dryer.

The application of either rotary dryer or fluidized bed technologies can sanitize the material. Sanitization means killing all of the bacteria. Since the residence time in the fluidized bed dryer is relatively short, it must be operated at a temperature around 400° F. for sanitization. Sanitization in a rotary dryer would require the glass to be heated to 250°-300° F. The flame temperature required to heat glass to these temperatures will depend on residence time; i.e., shorter residence times require higher temperatures. Another option for sanitization is to operate the rotary dryer at the minimum temperature to achieve separation and glass liberation and employ a fluidized bed dryer at the end of the process at the appropriate temperature. The maximum drying temperature and residence times in the dryer can be selected so that the organic material is not combusted in the dryer. Preventing combustion of the organic material eliminates possible additional emissions of combustion gases from burning the organics.

One currently preferred method of drying, sanitizing and disassociation is with a natural gas direct-fired co-current flow rotary dryer with lifters. Specifically, a currently preferred method of drying, sanitizing, and disassociation is with a co-current gas flow rotary dryer with standard and aggressive adjustable lifters. In such a method the temperature of the material exiting the dryer (e.g., about 140° F.) may be lower than the material entering the dryer, which is closer to the flame.

The order of the screen (and screening) 12 and the dryer (and drying) 20 may be optionally interchanged, such that the dirty MRF glass is sent through the screen 12 after being dried in the dryer 20.

After the glass has been screened and screened at 12, and dried (and optionally sanitized) at 20, ferrous metals are then removed at 24. An inline or rotating belt magnet 22 is used to remove the ferrous metals and send such ferrous metal material to a ferrous metal storage 24. After removal of ferrous metals using the magnet separator, the glass is screened in two stages.

In a first stage of screening at 26, foreign materials larger than the largest piece of glass are removed as the glass is received from the dryer and ferrous metal removal steps. Non-ferrous foreign material is removed from the foreign material via eddy current 14. The screen size is set depending on the size of the glass raw feed and residence time in the dryer. In one system, the screen size is between 1¼ and 1½ inches. A horizontal vibrating table screen may be used to screen the foreign materials of such size.

Then, in a second stage of screening at 28, a screen deck is used to separate the glass pieces into multiple size categories for respective density separation 30, 32, 34, 36, 38 within each size category, as described in detail below. Preferably a screen deck having screens of five size categories is used, which has been shown to work particularly well. Density separation separates lighter density materials from heavier density materials. This technology has been found to be most effective when the particles are of relatively similar size. Therefore, the more size classes created for separation of the particles, the more effective the density separation has been found to be. A field test with two size categories did not result in particularly satisfactory separation and both size fractions required further processing. A test with four particle size categories was shown to effectively separate glass from the lighter density foreign materials but in the smallest size, the smaller glass particles fluidized and went with the lighter fraction. This was solved by adding an optional fifth particle size category by splitting the smallest size into two categories. In a preferred embodiment, a single four-deck screen is used to create all five size categories simultaneously. However, fewer or more screens can be used in the screen deck to create fewer or more size categories as dictated by the range in glass particle sizes.

Also, more than one screen deck may be used, and each screen deck may have one or more screens to screen respective size categories. For example, in one embodiment, two screen decks are used instead of a single screen deck. A first of the two screen decks may include four screens that effectively separate +½ inch material. In this embodiment, all material screened out by the first sceen deck that is ½ inch or larger is sent to a crusher (e.g., pulverizer 48) and then returned to the first screen deck to be re-screened. All material screened by the first screen deck having a size smaller than ½ inch are passed onto a second of the two screen decks, which can then sort the −½ inch material into multiple, smaller size categories, (e.g., three size categories).

The selection of the upper and lower size of each particle size category has a significant effect on separation efficacy. A significant variable is the percentage size difference between the largest and smallest particle. Referring to Table 1, below, a preferred size range in each of five particle size categories of the screens is provided, along with the percent difference in size between the largest and smallest particle in each screen size category. During a test that resulted in excellent separation for the 1¼ inch to ¾ inch size category, the particles had a potential range of ½ inch; i.e., no more than 40 percent difference between the largest and smallest particle. In another test, a size category was set up for particles between ⅜ inch to 12 mesh. Even though this size differential was less than ⅓ of an inch, the separation was unacceptable; it was noted that the potential size different between the largest and smallest particle in the size category was an 82% size difference. Based on this knowledge, the optimal size categories are shown in Table 1, with the percent difference between the largest and smallest particle.

TABLE 1
Particle Size Ranges for Screen Deck
Five Size Categories

| | % |
|---|---|
| | Difference |
| Size range | in Size |
| 1¼−, ¾+ | 40% |
| ¾−, 7/16+ | 42% |
| 7/16−, ¼+ | 43% |
| ¼−, ⅛+ | 50% |
| ⅛−, 14 mesh− | 56% |

In a preferred embodiment, the screener 26 is preferably configured to separate glass into the five particle size categories shown in Table 1. Dirty MRF glass can come from many different sources and each source produces a glass residue unique to each MRF process and habits of the human population that the MRF serves. Therefore, variability in glass size and non-glass composition is expected and must be dealt with effectively. By sorting the material stream into five size categories, this variability becomes a non-factor.

After the material is sorted by size, the trash is separated from the glass using density separation, as the glass and most of the trash have different densities. (Non-ferrous trash of similar densities is dealt with later in the process.) Each size fraction is processed in a separation technology that employs vibration and air to separate materials by density. This technology is commonly known as a “Stoner” or “DeStoner”.

Standard Stoner technologies can each be used in the method. The density separation technology manufactured by General Kinematics (GK), called a DeStoner by GK, employs a vibrating trough that uses air to fluidize the bed material causing light material to rise above the heavier material. A jet of air (or “air knife”) at the right velocity and elevation blows the light material over a dividing plate and the heavy fraction drops to a conveyor below. This technology comes in “single knife” and “dual knife” versions. Dual knife Stoners have a built-in screen to divide the material into two size fractions and separation is accomplished with two air knives on separate troughs with separate blowers.

Density separation can be described using an exemplar ideal situation in which two different materials have the exact same size and shape. If these materials have a density different greater than 20%, the technology will yield perfect separation. In the real world, particles do not have the exact same size and shape. However, sorting the material into the five (or so) size categories comes as close as practical to mimicking the ideal situation. The Stoner separation of the trash for the ⅛ minus size category is effective down to approximately 10 to 12 mesh; i.e., only particles greater in size than 10 to 12 mesh are recovered and smaller glass particles are fluidized and slide downhill with contaminants. It has been found that the contaminants in 12 mesh minus material are the fine dust polished off the glass and other solid foreign objects and the fine dust from soil that is reduced to a very small size in the rotary dryer. A 40 mesh vibratory screen can be used at 37 to effectively separately these contaminants from the 12 to 40 mesh glass.

In a test, material that was dried in the rotary dryer was screened into two sizes of approximately equal weight: (1) 1¼ inch minus to ⅜ inch plus, and (2) 3/8 inch minus. A test run of the ⅜ inch plus size fraction on a single knife Stoner removed the vast majority of non-glass material; however, heavy plastic pieces, stones, ceramics, and plastic bottle caps were easily visible in the glass. For example, if a plastic screw-on bottle cap becomes filled with smaller glass particles it will act like a heavy particle instead of a light particle. These foreign materials will need to be removed in a subsequent step. A test run on the ⅜ inch minus fraction used different air pressure settings for the fluidization and air knife and resulted better separation, but the glass is still not clean enough.

The other “Stoner” technology employs a fluidized horizontally vibrating bed that is set on a slight angle. Given the correct vibration intensity, bed angle and air flow, heavier material is not fluidized and travels uphill and off the bed. The light material is fluidized and slides downhill and off the bed due to gravity. The reason the heavy particles flow uphill is due to horizontal vibration and lack of fluidization; i.e., the heavy particles are in constant contact with the bed and are pushed upward by the horizontal vibration. There are several manufacturers of these types of Stoners offering variations on the same principal and including, but are not limited to, Triple S Dynamics (SSS), Oliver and Carrier.

A test was run by screening the material into four different size categories: 1¼ inch-¾ inch; ¾ inch-½ inch; ½ inch-⅜ inch; and ⅜ inch-14 mesh. As previously discussed, the three largest categories produced outstanding separation but the ⅜ inch-14 mesh could not get the smaller glass particles to move uphill (or upgrade) with the larger glass particles. This is determined to be because the percent difference between the smallest and largest particles is too large. Splitting this size category into two sizes produced excellent results. The conclusion from these tests is that separating the glass into five size categories, using five Stoners 30, 32, 34, 36, 38, each for a separate particle size range category, is particularly advantageous for the efficient separation of glass from foreign particles.

A test run of the 1¼ inch to ⅜ inch particle size material containing foreign particles that was produced by the GK DeStoner on the SSS Stoner resulted in excellent separation. Both technology types will work, but the preferred technology is the SSS for several reasons. First the technology is simple and easy to master because the separation can be visualized as it occurs. Once the air speed, bed angle and vibration frequency are set, it requires very little attention because the variation in the feedstock size is removed by screening it into five size categories. Also, a single person can operate all five Stoners. Second, having five Stoner units provides flexibility to handle different glass feedstocks. Viewing the separation real time in the GK technology is not as easy and since only two size categories are processed, it will require constant attention to adjust air flows as feedstock size and composition varies.

Stoner manufacturers have previously tried to separate dirty MRF glass. However, in such prior instances, the Stoner (or DeStoner) did not adequately separate the materials and was rejected as a suitable technology for glass recovery. The reason those tests failed is that the glass was not previously dried to liberate the glass in accord with the method taught herein.

As an alternative to using a stoner for density separation of foreign particles, other types of separators can be used. The particles may be processed through a gravity separator. For example, one type of aspirator technology that may be used is called a Zig Zag air classifier or separator. The Zig Zag technology separates light-weight material particles (lights) from heavier particles (heavies) by cascading the mixed in-feed material through an upwards traveling air stream inside a Zig Zag-shaped enclosure. The design is based on density separation, an upwards traveling air stream takes with it the lightweight material particles, allowing separation of feedstock. Heavier material particles are not as affected by the air stream and discharge at the bottom of the Zig Zag enclosure. In the case of feedstock from separation at 38, the feedstock can be classified such that the heavies discharge into screen at 40 or, if sufficiently classified by the Zig Zag classifier, may be in a near clean glass state at 42.

It should be noted here also that Zig Zag air classifiers may be used as a replacement for the screening at 28 and the density separation at 30, 32, 34, 36, as well as 38. Such replacements may sort feedstock into multiple size categories with fewer pieces of equipment. In one example, the Zig Zag technology was tested with dirty MRF waste glass that was first dried in a rotary dryer and processed with a 1½ screen to remove the large particles of trash. The sample was then processed by a Zig Zag air classifier with 80% of the feed material going to the heavies and 20% going to the lights. The heavies contained 99% glass and 1% other material. The lights contained the remaining non-glass material including the dried organics that were abraded off the glass in the dryer. The majority of the glass contained in the lights were recovered by processing the material over two screens: a 5 mesh screen removed the +5 mesh material which was 100% non-glass; and a 40 mesh or 70 mesh screen removed the dirt and dried organics (fines). The −5 mesh material contained about 5% non-glass, mostly paper residuals. The 1% non-glass fraction of the heavies was composed of metals and heavy plastics, which required further removal, such as with optical sorting or pulverization.

Optical sorting (sometimes called digital sorting) is the automated process of sorting solid products using cameras and/or lasers. Depending on the types of sensors used and the software-driven intelligence of the image processing system, optical sorters can recognize objects' color, size, shape, structural properties, and chemical composition. The sorter compares objects to user-defined accept/reject criteria to identify and remove defective products and foreign material (FM) from the production line or to separate product of different grades or types of materials. The FM is removed by short and intense jets of air as the particle passes over a bar that has many small aperture holes. The air jets are computer controlled and when FM is detected, a jet of air hits the particle as it passes over the bar. In one embodiment, two optical devices are used: one optical device that measures visible reflection from a particle to remove metals; and one optical device that measures near-infrared reflection to remove plastic. Since all of the paper is separated with the flights in the drying process, there is no need for optical detection of fibrous materials.

Another other method for removing the 1% non-glass fraction is to pulverize all of the heavies in a device that reduces the glass to less than ¼ inches in size but does not reduce the size of the metals and hard plastic. One such device is a vertical shaft impactor (VSI) which is classified as an impact type pulverizer. A VSI consists of a vertical shaft connected to an electric motor with a rotor plate attached to the top of the shaft. There are many types of rotors with the simplest having vertical plates attached to the rotor. As the motor spins the rotor, material is fed onto the rotor which throws it against a strike plate. The motor rotational speed is adjusted to obtain the optimal pulverization of the material. The pulverized material is then processed on a screen with the desired aperture size so as to allow passage of the glass, but not the non-glass. The end result is extraordinary clean glass. There are many pulverizing technologies that can be utilized, including, but not limited to, hammer mills, jaw crushers, cone crushers, etc.

One advantage of the optical sorter method is that the glass need not be pulverized, which may allow for subsequent optical sorting steps to segregate the glass by color. On the other hand, pulverization of the glass by a VSI or other pulverization device results in glass particles that are too small to optically segregate by color. The pulverizer and screen method may also have an advantage of requiring significantly less capital than optical sorting methods.

Turning back to the exemplary workflow in FIG. 1, after density separation at 38, the smallest range of particles is further screened at 40 to remove fines, which are sent to trash storage 18. The resulting glass from density classification using stoners 30, 32, 34, 36, 38 and fine screen 40 is provided at a near clean state 42.

Then, the glass is optionally optically sorted at 44 to segregate the clean flint cullet 46 from the colored recycled glass. Flint cullet is optical glass that has a relatively high index and low Abbe number (high dispersion). Flint glasses are arbitrarily defined having an Abbe number of 50 to 55 or less, and refractive indices ranging between 1.45 and 2.00. Potential end-use products for the cleaned flint cullet include an extremely bright and white glass powder that can be used as a pozzolan in architectural concrete products or as industrial filler. If a significant percentage of the clean glass is colored glass, the glass cannot be used for such end-use products. Since the raw feedstock is mixed color, optical sorting technology is employed to isolate the flint cullet from the colored glass, so that the flint cullet can be used as a feedstock for the white pozzolan and industrial filler. The two largest size categories of glass from the Stoner, 7/16 inch to 1¾ inch, are processed by the optical sorter, and separated into a clean flint glass storage bin 46.

The objective of the optical sorting is to minimize the percentage of non-flint glass within the clean flint glass storage 46 to less than 2 percent. This can be accomplished with one optical sorter that is calibrated to minimize non-flint colors, but allows some minimal degree of flint glass to pass with the non-flint fraction. Although this does not maximize the capture of flint glass, it does provide sufficient flint glass for the targeted products at a very high purity level. Optionally, additional separation and capture of a higher percentage of flint glass can be carried out with additional optical sorter(s) in series. It is appreciated that if a white pozzolan, a white industrial filler, or other glass product requiring a higher percentage of flint glass are not intended end-use products, then the step of sorting flint cullet from the colored glass cullet can be eliminated from the process.

The near clean non-flint glass exiting the optical sorter 44 may still have hard stones and heavy non-ferrous objects therewithin. This is because such objects have similar densities to glass, and will therefore remain with the glass portion through density separation within the Stoners 30, 32, 34, 36 and 38. After the optional optical sorting at 44, such like density impurities are removed from the glass. This is accomplished by pulverizing the glass at 48, preferably using a vertical shaft impactor (VSI) mill equipped with a tubular rotor. A VSI mill comminutes particles of material into smaller (finer) particles by impacting the particles against a hard surface inside the mill (called the wear plate). The tubular rotor increases the impact velocity of the glass on the wear plate. A screen 50 with an aperture size larger than the largest comminuted glass particles will screen out any remaining foreign objects that are not reduced in size by the VSI. The foreign objects are sent by eddy current 16 to remove non-ferrous objects and then to the trash storage 20.

All of the remaining clean glass 52 at this stage (excepting the prior separated flint glass) is collected into clean glass storage containers, bunkers, or locations.

In addition, or as an alternative, to pulverizing the glass at 48, removal of impurities from the glass may be accomplished at least in part with a metal detector for detecting impurities such as brass fittings and stainless steel. For example, in one embodiment, a trap door may be used to remove those metals. However, since some glass may fall with the metals, the fallen material is crushed, and the metals are screened out. Thus, rather than crushing all of the near clean non-flint glass exiting the optical sorter 44, a smaller fraction of the near clean non-flint glass is crushed.

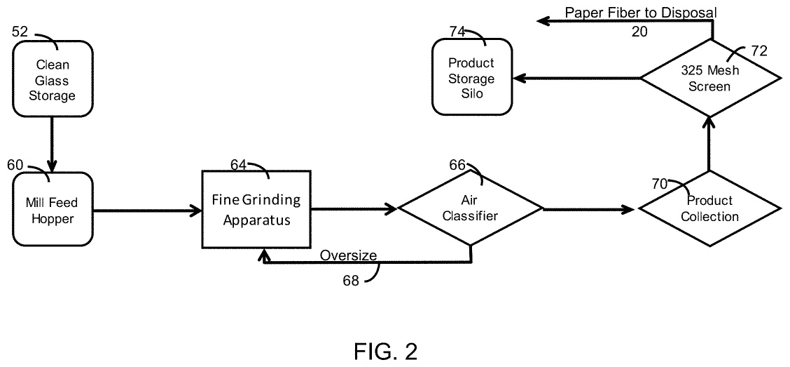

Once the clean glass is collected at storage containers 52, it is ready to be further processed, at either an immediately following step or a later time as needed, as shown in FIG. 2. For many end-use purposes, the glass, once clean, often requires fine grinding, although such additional grinding is not a necessary part of the process for cleaning the MRF glass. The glass designated for glass particles, glass powders and glass fillers that do not have a whiteness or brightness requirement is preferably processed separately from the flint glass, as described below.

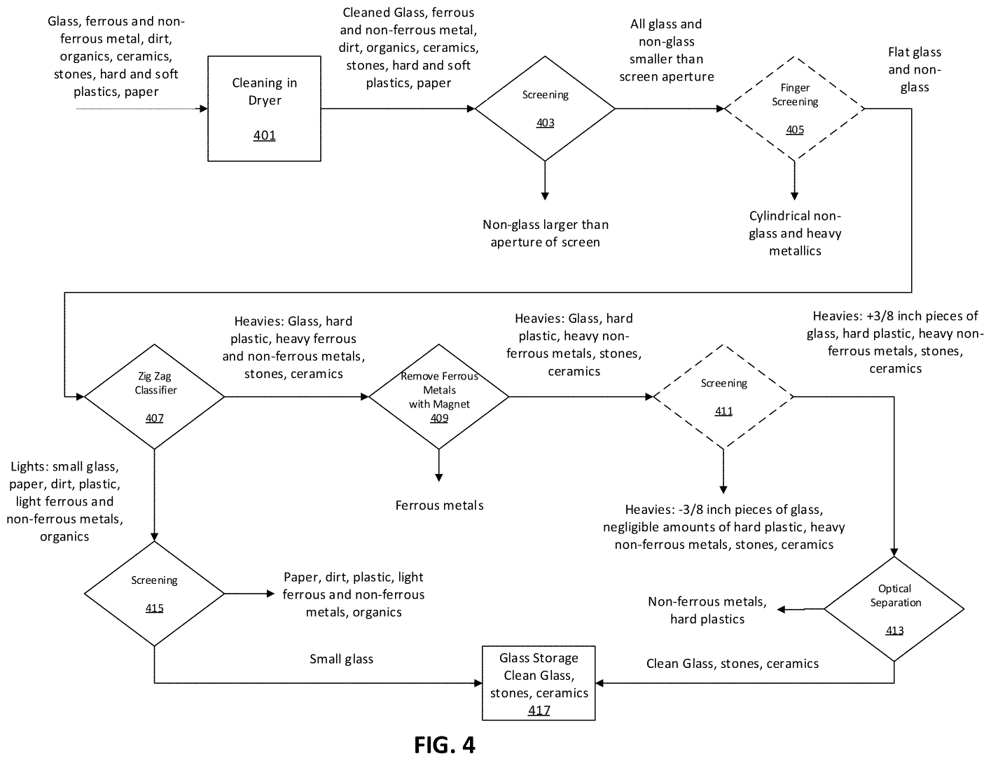

FIG. 4 illustrates an alternative workflow to that shown in FIG. 1 and described above. At 401, waste MRF glass (mixed with other trash including ferrous and non-ferrous metals, plastics, ceramics, dirt, stones, and organics) is cleaned first in a dryer, such as a rotary dryer 300 described above. All components of the waste glass are dried, including the residual organics (e.g., food). As a result of heating and tumbling in the dryer, the various components are disassociated, the dried organics are abraded from the glass, and the glass is reduced in size due to breakage. Then, after drying at 401, at 403 non-glass materials larger than a predetermined aperture size of a screen are screened out of the mixture exiting the dryer, while all of the glass and all of non-glass that is smaller than the aperature size of the screen (“non-glass fraction”) passes through the screen for further processing. At 405 there may be an optional finger screen of the non-glass fraction. Finger screens come in many configurations and are used extensively in recycling because they do not bind or clog. One characteristic of some finger screens is that they allow flat objects (e.g., broken glass) to pass through, while not permitting cylindrical shaped objects to pass. Thus, in the event there are heavy metallic objects (e.g., brass fittings) and cylindrical non-glass objects in the non-glass fraction, they will be further screened out by the finger screen. At 407, a Zig Zag air classifier may be used to separate the remaining heavies (most of the glass, hard plastics, heavy ferrous metals and non-ferrous metals, stones, ceramics) from lights (small glass particles, paper, most plastic, dirt, light metals, organics). At 409, the ferrous metals can be removed from the Zig Zag heavies using a magnet. At 411 an optional screen may be used to remove smaller pieces of glass from the heavies (e.g., less than ⅜ inch) prior to the optical separator. The reason for this screening at 411 is that there is very little non-glass in the −⅜ inch fraction and reducing the volume of the remaining glass fraction in the heavies and increasing the size of glass improves the effectiveness of the optical separator. At 413, an optical separator can be used to remove any remaining non-ferrous metals and plastics in the +⅜ inch fraction of the heavies. Small amounts of ceramics and stones end up with the glass, which does not harm the ground glass products. The lights from the Zig Zag air classifier can go to an optional screen deck at 415 or a series of two screens. A 5-mesh screen can screen out a majority of the non-glass material and a 40-mesh or 70-mesh screen can screen out dirt and dried organics. The remaining material is mostly glass with small amounts of paper contamination. Depending on the raw feedstock, the Zig Zag separator has the capability of separating 95% of the glass or more to the heavies. In this event, screening the lights at 415 may not be deemed necessary.

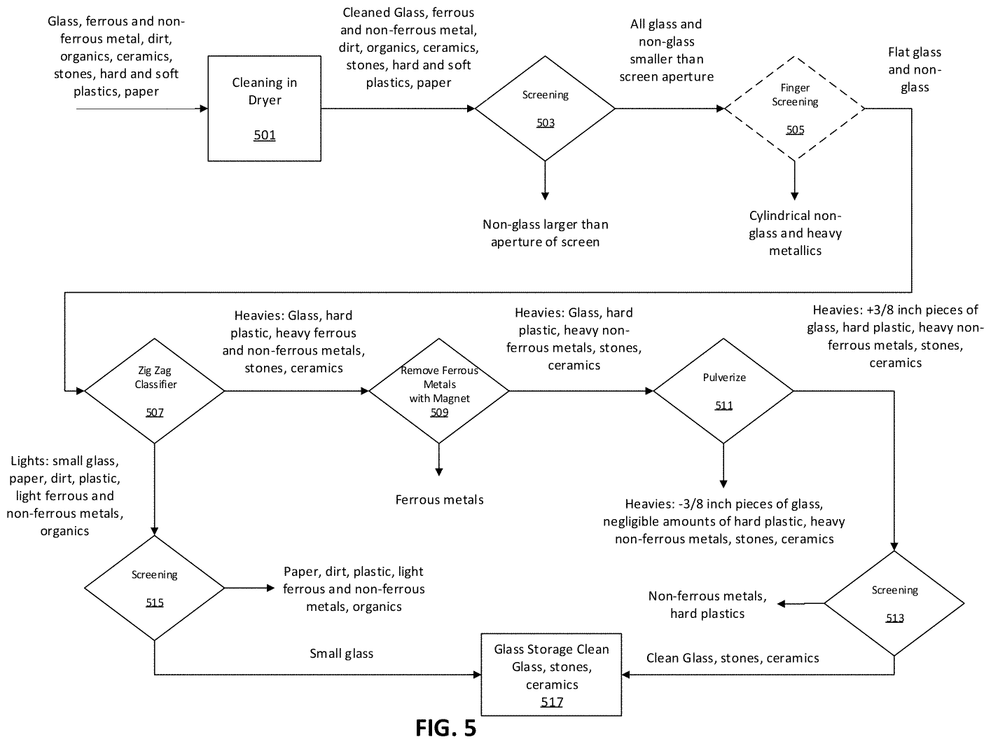

The workflow shown in FIG. 4 may be modified as shown in FIG. 5, where like elements are incremented by ‘100’. The workflow in FIG. 5 utilizes a non-optional VSI in a pulverizing process at 511 in place of the optional screening at 411 in the workflow in FIG. 4. The glass can be reduced to less than ¼ inch by the VSI and the non-glass fraction, which is not reduced in size, can be screened out in 513. All other steps of the modified workflow would be the same as shown in FIG. 4 and described hereinabove. The clean glass at 417 in the workflow of FIG. 4 and at 517 in the workflow of FIG. 5 is effectively the same quality as the clean glass 52 in workflow of FIG. 1.

The clean glass 52 is transferred from its storage to a mill feed hopper 60 which supplies the clean glass to a fine grinding apparatus 64. Fine grinding can occur in any type of fine grinding apparatus 64 sufficiently robust to grind glass including, but not limited to, all types of ball mills and tube mills, vertical roller mills, attritor mills (stirred media mills and dense packed stirred media mills), vibratory mills, jet mills (or Air Classification Mills), ISA mills, Roller mills, High Pressure Grinding Rolls (HPGR) and Aerosion Ltd's “disintegrator” technology. The ball mill is proven technology for grinding bottle glass and is reasonably efficient when grinding feed stock of this size. These ultra-fine particles create a very large specific surface area which is positively related to pozzolanic reactivity.

Fine grinding 64 occurs in a closed-loop circuit utilizing a dynamic air classifier 66 that can produce a relatively narrow particle size distribution consistently. The air classifier 66 is employed to separate particles from the fine grinding apparatus 64 when they become the target size. The air classifier is an industrial machine which separates materials by a combination of size, shape, and density. It works by injecting the material stream to be sorted into a chamber that contains a column of rising air. Inside the separation chamber, air drag on the objects supplies an upward force which counteracts the force of gravity and lifts the material to be sorted up into the air. Due to the dependence of air drag on object size and shape, the objects in the moving air column are sorted vertically and can be separated in this manner.

The many air classifier technologies are generally classified as either static or dynamic. One dynamic air classifier technology employs a rotor with many blades that at the right rotational velocity allows lightweight particles to pass through without contacting the rotor blades and slower moving heavy particles make contact with the blades and are knocked to the outer side of the classifier and are conveyed back to the grinding device for additional size reduction. The particles removed from the air classifier are separated from the air stream by a cyclone or bag house. The rotor rotational speed determines the material cut point size. This is the preferred air classification technology.

The particle size targeted by these grinding circuits ranges from a median particle size of 12 micron down to 4 micron and smaller depending on the type and size of grinding device. The fine grinding apparatus 64 may have a different throughput rate depending on device type and size.

Another optional step is to include further grinding and/or classification devices to produce even smaller particle sizes. One method is to perform secondary air classification on the 10 or 12 micron median size particle material that splits it into two sizes, each with their own particle size distribution. The larger material can either be marketed as a different product if such a market exists. Otherwise, it must go back into the grinding device for further size reduction. This works well for most grinding devices except vertical roller mills because the addition of fine material into the mill has a cushioning effect that reduces throughput rates.

If finer grinds down to submicron size are contemplated, there are at least two options that can handle grinding to sizes ranging from 5-6 micron median particle size to submicron sizes: a jet mill and dense packed stirred media mill.

The grinding friction in some dense packed stirred media mills generate significant heat and the units must be equipped with a metal jacket to circulate water for cooling. The preferred option is a dense packed stirred media mill because it requires a fraction of the energy that a jet mill requires to achieve these ultra-fine grinds.

In order to increase process throughput in the fine grinding stage, multiple hopper/feeders 60 and fine grinding apparatus 64 may be used to convey the glass and grind the glass to a suitable size, with oversize glass particles being returned at 68 by one or respective air classifiers 66 for further fine grinding in the respective mills 64.

Pozzolanic glass particles that are intended for use in concrete products that use gray Portland cement do not have whiteness or brightness requirements, whereas flint glass particles can be used to manufacture products requiring extremely white and bright powder, such as industrial filler and white cement concrete products. The final processing of these glass products may utilize separate hoppers/feeders, grinding apparatus, and air classifiers to prevent color contamination of the white products.

Once the glass particles are ground to the desired particles size range, with a defined particle distribution, they are collected at 70. From collection 70, the glass preferably passes through a final screening 72. It is recognized that not all of the paper labels are removed by the abrasion in the rotary dryer or the Stoner separation technology. When the glass is ground in the fine grinding apparatus, the paper is fully liberated into individual fibers which tend to attract each other and ball up into small dust balls. The overall quantity is small (much less than 1%) but depending on the actual quantity and end use of the glass powder, it may or may not be a problem. Architectural concrete products do not tolerate impurities well whereas it is not a problem for most gray concrete products. Further, the presence of paper fiber eliminates the glass for use in most industrial filler applications. The paper fiber can be screened out by a 45-325 micron screen at 72, and sent to trash 20, yielding an extremely clean powdered glass product. The screening can be done for any size material that is 12 micron median particle size or less. The yielded glass powder 74 is very clean and suitable for all industrial fillers and architectural concrete applications. The glass powder 74 is sent to storage, bagging, truck load out, or location for later or immediate use.

The final glass powder has been tested for overall loss on ignition (LOI). Sample test results show a LOI of down to 0.05%±0.2, substantially better than the LOI of 1.44% from prior art that used a different method which also does not liquid wash the dirty glass to clean the glass. This indicates that the clean glass from the described method was substantially free of organics, and at a level that is inconsequential to the performance of a pozzolan. The LOI of glass cleaned in accord with the described method is repeatable, and will consistently have a LOI not exceeding 1%, and preferably less than 0.75%, more preferably less than 0.5%, and even more preferably less than 0.25%.

From the above, it is recognized that the clean glass can be processed into a number of products that range in size from sub-micron to 1½ inch glass aggregate. These include, but are not limited to, fine grind products such as pozzolans for use as a cement replacement in concrete and industrial fillers for use in coatings and resins, sand sized products such as abrasive blasting media, water filtration media, specialty sands paver joint sand, sealcoating sand and non-crystalline silica play sand, and finally aggregate sized products for use in landscaping, decorative concrete, fire pits, etc.

Also, where the system and process are described with multiple references to eddy currents and trash storage, it is recognized that that a single or multiple eddy current can be used, and similarly a single or multiple trash storage can be used, or preferably strategically positioned within or throughout the overall system.

There have been described and illustrated herein embodiments of processes to clean and fine grind glass. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its scope as claimed.

What is claimed is:

1. A method of processing a mixture of dirty glass and trash from a material recovery facility, comprising:
a) tumbling the mixture in a rotary drum,
the tumbler having a series of lifters arranged about a peripheral sidewall of the drum such that when the drum is rotated the lifters lift the mixture to a height before dumping the mixture from the height sufficient to cause breakage and reduction in size of the glass, wherein
the mixture is advanced into an entrance to the drum, through a passageway in the drum, and out of an exit in the drum, and
the glass leaving the exit of the drum has a particle size that, on average, is less than two-thirds the size of the particle size of the glass entering the entrance to the drum;
b) drying the glass while tumbling the glass in the rotary drum, wherein drying includes flowing a heated gas in a co-current direction with the glass;
c) after the glass exits the exit of the drum, separating ferrous metals from the glass;
d) separating the glass into multiple particle size categories; and
e) in each of the multiple particle size categories, separating the glass from the trash to recover size categorized clean glass.

2. The method of claim 1, wherein:
the method is completely performed without washing the glass with a liquid.

3. The method of claim 1, further comprising:
collecting contaminants removed from the glass while the glass is tumbled in the rotary drum.

4. The method of claim 1, further comprising:
adjusting the lifters to set the predetermined height.

5. The method of claim 1, wherein:
a temperature of the gas flowing is sufficient to dry any organic materials and labels attached to the glass, but is insufficient to cause the organic materials and labels to be combusted.

6. The method of claim 1, further comprising:
before or after tumbling at a), screening to further separate a portion of trash from the glass, the first portion comprising plastic materials.

7. The method of claim 1, further comprising:
wherein the glass includes flint glass and colored glass, and after the glass exits the drum, segregating flint glass from colored glass.

8. The method of claim 1, wherein:
the segregating includes optically sorting the flint glass and colored glass from each other.

9. The method of claim 1, further comprising:
fine grinding the clean class into smaller size particles.

10. The method according to claim 9, further comprising:
after fine grinding, remove paper fiber from the clean glass.

11. The method according to claim 1, further comprising:
pulverizing the clean glass.

12. A method of processing a mixture of dirty glass and trash from a material recovery facility, comprising:
a) tumbling the mixture in a rotary drum, the drum having a series of lifters arranged about a peripheral sidewall of the tumbler such that when the drum is rotated the lifters lift the mixture to a height before dumping the mixture from the height sufficient to cause breakage and reduction in size of the glass, wherein
the mixture is advanced into an entrance to the drum, through a passageway in the drum, and out of an exit in the drum, and
the glass leaving the exit of the drum has a particle size that, on average, is less than two-thirds the size of the particle size of the glass entering the entrance to the drum;
b) drying the glass in the rotary drum while tumbling the glass in the rotary drum, wherein drying includes flowing a heated gas in a co-current direction with the glass;
c) after the mixture exits the exit of the drum, separating ferrous metals from the mixture;
d) density separating the mixture into a heavy component and a light component, the heavy component containing a glass fraction and non-glass fraction, and the light component including only dried organic materials removed by the tumbling; and
e) for the heavy component, separating the glass fraction from the non-glass fraction.

13. The method of claim 12, wherein the method is completely performed without washing the glass with a liquid.

14. The method of claim 12, further comprising:
collecting contaminants removed from the glass while the glass is tumbled in the rotary drum.

15. The method of claim 12, wherein:
a temperature of the gas flowing is sufficient to dry any organic materials and labels attached to the glass, but is insufficient to cause the organic materials and labels to be combusted.

16. The method of claim 12, further comprising:
before or after tumbling at a), screening to further separate a portion of trash from the glass, the portion comprising plastic materials.

17. The method of claim 12, wherein separating the glass fraction from the non-glass fraction in e) includes at least one of optical sorting and pulverizing the glass.

18. The method of claim 12, wherein separating the glass fraction from the non-glass fraction in e) includes pulverizing the glass to less than 0.25 inch in size and screening the pulverized glass to a size less that allows passage of the glass through the screen but not the non-glass fraction.
